(19) United States
(12) Patent Application Publication
(10) Pub. No.: US 2022/0049051 A1
(43) Pub. Date: Feb. 17, 2022

(54) PROCESS FOR PREPARING A POLYESTER USING A 4-MEMBERED RING LACTONE

(71) Applicant: Covestro Intellectual Property GmbH & Co. KG, Leverkusen (DE)

(72) Inventors: Martin Machat, Köln (DE); Peter Nordmann, Dormagen (DE); Marina Reithmeier, Köln (DE); Elisabeth Vogelsang, Köln (DE)

(21) Appl. No.: 17/312,485

(22) PCT Filed: Dec. 16, 2019
(86) PCT No.: PCT/EP2019/085296

§ 371 Date: Jun. 10, 2021

(30) Foreign Application Priority Data
Dec. 21, 2018 (EP) 18215195.1

(51) Int. Cl. C08G 63/82; C08G 63/08; C08L 75/06

(52) U.S. Cl. CPC C08G 63/823; C08L 75/06; C08G 63/08

(57) ABSTRACT

The invention provides a process for preparing polyesters by reacting an H-functional starter substance with a lactone in the presence of a Brønsted-acidic catalyst which comprises initially charging the H-functional starter substance and the Brønsted-acidic catalyst to form a mixture i) and subsequently adding the lactone to the mixture i), wherein the process is carried out without adding an aromatic solvent and wherein the H-functional starter substance is an OH-functional starter substance and/or a COOH-functional starter substance and wherein the lactone is a 4-membered ring lactone. The invention further provides polyesters obtainable by the method of the invention.

The invention provides a process for preparing polyesters by reaction of an H-functional starter substance with a lactone in the presence of a Brønsted-acidic catalyst, comprising initially charging the H-functional starter substance and a Brønsted-acidic catalyst to form a mixture i) and subsequently adding the lactone to the mixture i), wherein the process is performed without the addition of an aromatic solvent, wherein the H-functional starter substance is an OH-functional starter substance and/or a COOH-functional starter substance and wherein the lactone is a 4-membered-ring lactone.

The invention further provides polyesters obtainable by the process according to the invention.

U.S. Pat. No. 5,032,671 discloses a process for preparing polymeric lactones by reaction of an H-functional starter substance and lactones in the presence of a double metal cyanide (DMC) catalyst. The working examples disclose the reaction of polyether polyols with ε-caprolactone, δ-valerolactone or β-propiolactone to afford polyether-polyester polyol block copolymers, wherein these reactions are performed in the presence of large amounts of 980 ppm to 1000 ppm of the cobalt-containing DMC catalyst and in the presence of organic solvents, wherein the resulting products have a broad molar mass distribution of 1.32 to 1.72. This process further requires a workup step wherein the products are filtered through diatomaceous earth and the solvent is subsequently removed. For the reaction of the polyether polyol with β-propiolactone, only the formation of a resulting polyester with a molar mass of 10000 g/mol is postulated. This process further requires a workup step wherein the products are filtered through diatomaceous earth and the solvent is subsequently removed.

WO2008/104723 A1 discloses a process for preparing a polylactone or polylactam, wherein the lactone or lactam is reacted with an H-functional starter substance in the presence of a non-chlorinated aromatic solvent and a sulfonic acid on a microliter scale. Employed here as the H-functional starter substance are low molecular weight monofunctional or polyfunctional alcohols or thiols, wherein the working examples disclose (monofunctional) n-pentanol with ε-caprolactone or δ-valerolactone in the presence of large amounts of trifluoromethanesulfonic acid of 1 mol %-10 mol %.

Couffin et al. Poly. Chem 2014, 5, 161 disclose a selective O-acyl opening of beta-butyrolactone with H-functional starter substances such as for example pentanol, butane-1,4-diol and polyethylene glycols in deuterated benzene and in the presence of trifluoromethanesulfonic acid, all reaction components being initially charged and then reacted (batch mode). The reactions are performed on a microliter scale and large amounts of the acid catalyst of 1 mol %-5 mol % based on the amount of employed lactone are used.

GB1201909 likewise discloses a process for preparing polyesters by reaction of a lactone with an H-functional starter compound in the presence of an organic carboxylic acid or sulfonic acid having a pKa at 25° C. of less than 2.0. All reaction components such as short-chain alcohols and ε-caprolactone or mixtures of isomeric methyl-epsilon-caprolactones were initially charged in large amounts of trichloro- or trifluoroacetic acid catalyst and reacted in a batch process for at least 20 hours, resulting in solids or liquid products.

It was therefore an object of the present invention to provide a simplified and industrially more efficient process for preparing polyesters which remedies the disadvantages of the prior art preparation process.

The reaction should be effected in the presence of minimum amounts of a highly reactive, heavy-metal-free catalyst to afford the desired polyester products, with the use of aromatic solvents being dispensed with so that if possible no removal of catalysts and/or solvents is necessary prior to further processing. Furthermore, the intention is to reduce the formation, known in the literature, of undesirable unsaturated byproducts such as crotonic acids as a result of rearrangement and elimination reactions.

A further aspect is the provision of a reliable and scalable preparation process by improved process control, for example by reduction of strong exothermicities during the conversion of the reaction components to the polyester, in order to improve process control.

It has surprisingly been found that the object of the invention is achieved by processes for preparing a polyester by reaction of an H-functional starter substance with a lactone in the presence of a Brønsted-acidic catalyst, comprising the following steps:
i) initially charging the H-functional starter substance and the Brønsted-acidic catalyst to form a mixture i);
ii) adding the lactone to the mixture i);
   wherein the process is performed without the addition of an aromatic solvent; wherein the H-functional starter substance is an OH-functional starter substance and/or a COOH-functional starter substance and wherein the lactone is a 4-membered-ring lactone.

H-Functional Starter Substance

In the process according to the invention, an OH-functional starter substance and/or a COOH-functional starter substance is/are used. Here, an OH-functional starter substance is understood to be a compound having at least one free hydroxyl group, and a COOH-functional starter substance is understood to be a compound having at least one free carboxyl group.

As H-functional starter substances, for example, one or more compounds may be selected from the group comprising monohydric or polyhydric alcohols, monobasic or polybasic carboxylic acids, hydroxycarboxylic acids, hydroxy esters, polyether polyols, polyester polyols, polyester ether polyols, polyether carbonate polyols, polyether ester carbonate polyols, polycarbonate polyols, polycarbonates, polytetrahydrofurans (e.g. PolyTHF® from BASF, such as PolyTHF® 250, 650S, 1000, 1000S, 1400, 1800, 2000), polyacrylate polyols, castor oil, the mono- or diglyceride of ricinoleic acid, monoglycerides of fatty acids, chemically modified mono-, di- and/or triglycerides of fatty acids, and C1-C24 alkyl fatty acid esters containing on average at least 2 OH groups per molecule. Examples of C1-C23 alkyl fatty acid esters containing on average at least 2 OH groups per molecule are commercial products such as Lupranol Balance® (from BASF AG), Merginol® products (from Hobum Oleochemicals GmbH), Sovermol® products (from Cognis Deutschland GmbH & Co. KG), and Soyol®™ products (from USSC Co.).

Monofunctional starter substances used may be alcohols, thiols and carboxylic acids. Monofunctional alcohols that may be used include: methanol, ethanol, 1-propanol, 2-propanol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, 1-dodecanol, 1-hexadecanol, phenol, 2-hydroxybiphenyl, 3-hydroxybiphenyl, 4-hydroxybiphenyl, 2-hydroxypyridine, 3-hydroxypyridine, 4-hydroxypyridine. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Examples of polyhydric alcohols suitable as H-functional starter substances are dihydric alcohols (such as, for example, ethylene glycol, diethylene glycol, propylene glycol, dipropylene glycol, propane-1,3-diol, butane-1,4-diol, butene-1,4-diol, butyne-1,4-diol, neopentyl glycol, pentanetane-1,5-diol, methylpentanediols (such as, for example, 3-methylpentane-1,5-diol), hexane-1,6-diol; octane-1,8-diol, decane-1,10-diol, dodecane-1,12-diol, bis(hydroxymethyl)cyclohexanes (such as, for example, 1,4-bis(hydroxymethyl)cyclohexane), triethylene glycol, tetraethylene glycol, polyethylene glycols, dipropylene glycol, tripropylene glycol, polypropylene glycols, dibutylene glycol and polybutylene glycols); trihydric alcohols (such as, for example, trimethylolpropane, glycerol, trishydroxyethyl isocyanurate, castor oil); tetrahydric alcohols (such as, for example, pentaerythritol); polyalcohols (such as, for example, sorbitol, hexitol, sucrose, starch, starch hydrolyzates, cellulose, cellulose hydrolyzates, hydroxy-functionalized fats and oils, especially castor oil), and also all modification products of these aforementioned alcohols with different amounts of ε-caprolactone.

Suitable monobasic carboxylic acids include methanoic acid, ethanoic acid, propanoic acid, butanoic acid, pentanoic acid, hexanoic acid, heptanoic acid, octanoic acid, lactic acid, fluoroacetic acid, chloroacetic acid, bromoacetic acid, iodoacetic acid, difluoroacetic acid, trifluoroacetic acid, dichloroacetic acid, trichloroacetic acid, oleic acid, salicylic acid and benzoic acid.

Suitable polybasic carboxylic acids include oxalic acid, malonic acid, succinic acid, glutaric acid, adipic acid, pimelic acid, suberic acid, azelaic acid, sebacic acid, trimesic acid, fumaric acid, maleic acid, 1,10-decanedicarboxylic acid, 1,12-dodecanedicarboxylic acid, phthalic acid, isophthalic acid, terephthalic acid, pyromellitic acid and trimellitic acid.

Hydroxycarboxylic acids which are suitable as H-functional starter substances include, for example, ricinoleic acid, glycolic acid, lactic acid, 3-hydroxypropionic acid, malic acid, citric acid, mandelic acid, tartronic acid, tartaric acid, mevalonic acid, 4-hydroxybutyric acid, salicylic acid, 4-hydroxybenzoic acid and isocitric acid.

The H-functional starter substances may also be selected from the substance class of the polyether polyols, especially those having a molecular weight Mn in the range from 50 to 4000 g/mol. Preference is given to polyether polyols formed from repeating ethylene oxide and propylene oxide units, preferably having a proportion of propylene oxide units of 35% to 100%, particularly preferably having a proportion of propylene oxide units of 50% to 100%. These may be random copolymers, gradient copolymers, alternating copolymers or block copolymers of ethylene oxide and propylene oxide. Suitable polyether polyols constructed from repeating propylene oxide and/or ethylene oxide units are for example the Desmophen®, Acclaim®, Arcol®, Baycoll®, Bayfill®, Bayflex®, Baygal®, PET® and Polyether polyols from Covestro AG (e.g. Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homopolyethylene oxides are for example the Pluriol® E products from BASF SE, suitable homopolypropylene oxides are for example the Pluriol® P products from BASF SE, suitable mixed copolymers of ethylene oxide and propylene oxide are for example the Pluronic® PE or Pluriol® RPE products from BASF SE.

The H-functional starter substances may also be selected from the substance class of the polyester polyols, especially those having a molecular weight Mn in the range from 50 to 4500 g/mol. Polyester polyols used may be at least difunctional polyesters. Polyester polyols preferably consist of alternating acid and alcohol units. Examples of acid components which can be used include succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride, or mixtures of the stated acids and/or anhydrides. Examples of alcohol components used include ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol, or mixtures of the stated alcohols. The resulting polyester polyols have terminal hydroxyl and/or carboxyl groups.

In addition, H-functional starter substances used may be polycarbonate diols, especially those having a molecular weight Mn in the range from 50 to 4500 g/mol which are prepared, for example, by reaction of phosgene, dimethyl carbonate, diethyl carbonate or diphenyl carbonate and difunctional alcohols or polyester polyols or polyether polyols. Examples for polycarbonates can be found, for example, in EP-A 1359177. Polycarbonate diols that may be used include for example the Desmophen® C line from Covestro AG, for example Desmophen® C 1100 or Desmophen® C 2200.

In a further embodiment of the invention, it is possible to use polyether carbonate polyols (for example Cardyon® polyols from Covestro), polycarbonate polyols (for example Converge® polyols from Novomer/Saudi Aramco, NEOSPOL polyols from Repsol etc.) and/or polyether ester carbonate polyols as H-functional starter compounds. In particular, polyether carbonate polyols, polycarbonate polyols and/or polyether ester carbonate polyols may be obtained by reaction of alkylene oxides, preferably ethylene oxide, propylene oxide or mixtures thereof, optionally further comonomers, with C02 in the presence of a further H-functional starter compound and using catalysts. These catalysts include double metal cyanide catalysts (DMC catalysts) and/or metal complex catalysts for example based on the metals zinc and/or cobalt, for example zinc glutarate catalysts (described for example in M. H. Chisholm et al., Macromolecules 2002, 35, 6494), so-called zinc diiminate catalysts (described for example in S. D. Allen, J. Am. Chem. Soc. 2002, 124, 14284) and so-called cobalt salen catalysts (described for example in U.S. Pat. No. 7,304,172 B2, US 2012/0165549 A1) and/or manganese salen complexes. An overview of the known catalysts for the copolymerization of alkylene oxides and C02 may be found for example in Chemical Communications 47 (2011) 141-163. The use of different catalyst systems, reaction conditions and/or reaction sequences results in the formation of random, alternating, block-type or gradient-type polyether carbonate polyols, polycarbonate polyols and/or polyether ester carbonate polyols. To this end, these polyether carbonate polyols, polycarbonate polyols and/or polyether ester carbonate polyols used as H-functional starter compounds may be prepared beforehand in a separate reaction step.

The H-functional starter substances generally have an OH functionality (i.e. the number of H atoms active in respect of the polymerization per molecule) of 1 to 8, preferably of 2 to 6 and particularly preferably of 2 to 4. The H-functional starter substances are used either individually or as a mixture of at least two H-functional starter substances.

Preferred H-functional starter substances are alcohols with a composition according to the general formula (1),

HO—(CH2)X—OH (1)

where x is a number from 1 to 20, preferably an even number from 2 to 20. Examples of alcohols of formula (VII) are ethylene glycol, butane-1,4-diol, hexane-1,6-diol, octane-1,8-diol, decane-1,10-diol and dodecane-1,12-diol. Further preferred H-functional starter substances are neopentyl glycol, trimethylolpropane, glycerol and pentaerythritol.

Preference is further given to using, as H-functional starter substances, water, diethylene glycol, dipropylene glycol, castor oil, sorbitol and polyether polyols formed from repeating polyalkylene oxide units.

Particularly preferably, the H-functional starter substances are one or more compounds selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, diethylene glycol, dipropylene glycol, glycerol, trimethylolpropane, di- and trifunctional polyether polyols, where the polyether polyol has been formed from a di- or tri-H-functional starter substance and propylene oxide or a di- or tri-H-functional starter substance, propylene oxide and ethylene oxide. The polyether polyols preferably have an OH functionality of 2 to 4 and a molecular weight Mn in the range from 62 to 4500 g/mol and more particularly a molecular weight Mn in the range from 62 to 3000 g/mol.

In one embodiment of the process according to the invention, OH functionality is from 2 to 6 and a molecular weight of 40 g/mol to 2000 g/mol, preferably of 2 to 4 and preferably of 60 g/mol to 1000 g/mol.

In one embodiment of the process according to the invention, the H-functional starter substance is one or more compounds and is selected from the group consisting of ethylene glycol, diethylene glycol, dipropylene glycol, butane-1,3-diol, butane-1,4-diol, 1,1,1-trimethylolpropane, glycerol, pentaerythritol, sorbitol, sucrose, xylitol, propane-1,2-diol, propane-1,3-diol, succinic acid, adipic acid, glutaric acid, pimelic acid, maleic acid, phthalic acid, terephthalic acid, lactic acid, citric acid and salicylic acid.

Lactone

According to the technical generally valid understanding in organic chemistry, lactones are to be understood as meaning heterocyclic compounds, wherein lactones are formed by intramolecular esterification, i.e. the reaction of a hydroxyl functionality with a carboxyl functionality in a hydroxycarboxylic acid. They are therefore cyclic esters having a ring oxygen.

In one embodiment of the process according to the invention, the 4-membered-ring lactone is one or more compounds and is selected from the group consisting of propiolactone, β-butyrolactone, diketene, preferably propiolactone and β-butyrolactone.

Brønsted-Acidic Catalyst

In line with the customary definition in the art, Brønsted acids are to be understood as meaning substances capable of transferring protons to a second reaction partner, the so-called Brønsted base, typically in an aqueous medium at 25° C. In the context of the present invention, the term “Brønsted-acidic catalyst” is to be understood as meaning a non-polymeric compound, wherein the Brønsted-acidic catalyst has a calculated molar mass of 51200 g/mol, preferably of 51000 g/mol and particularly preferably of 5850 g/mol.

In one embodiment of the process according to the invention, the Brønsted-acidic catalyst has a pKa of less than or equal to 1, preferably of less than or equal to 0.

In one embodiment of the process according to the invention, the Brønsted-acidic catalyst is one or more compounds and is selected from the group consisting of aliphatic fluorinated sulfonic acids, aromatic fluorinated sulfonic acids, trifluoromethanesulfonic acid, perchloric acid, hydrochloric acid, hydrobromic acid, hydroiodic acid, fluorosulfonic acid, bis(trifluoromethane)sulfonimide, hexafluoroantimonic acid, pentacyanocyclopentadiene, picric acid, sulfuric acid, nitric acid, trifluoroacetic acid, methanesulfonic acid, paratoluenesulfonic acid, aromatic sulfonic acids and aliphatic sulfonic acids, preferably from trifluoromethanesulfonic acid, perchloric acid, hydrochloric acid, hydrobromic acid, hydroiodic acid, fluorosulfonic acid, bis(trifluoromethane)sulfonimide, hexafluoroantimonic acid, pentacyanocyclopentadiene, picric acid, sulfuric acid, nitric acid, trifluoroacetic acid, methanesulfonic acid, paratoluenesulfonic acid, methanesulfonic acid and paratoluenesulfonic acid, particularly preferably from trifluoromethanesulfonic acid, perchloric acid, hydrochloric acid, hydrobromic acid, hydroiodic acid, bis(trifluoromethane)sulfonimide, pentacyanocyclopentadiene, sulfuric acid, nitric acid and trifluoroacetic acid.

In one embodiment of the process according to the invention, the Brønsted-acidic catalyst is used in an amount of 0.001 mol % to 0.5 mol %, preferably of 0.003 to 0.4 mol % and particularly preferably of 0.005 to 0.3 mol %, based on the amount of lactone.

Solvent

In line with the customary definition in the art, a solvent is to be understood as meaning one or more compounds which dissolve the lactone, the H-functional starter compound and/or the Brønsted-acidic catalyst but without themselves reacting with the lactone, the H-functional starter compound and/or the Brønsted-acidic catalyst.

In one embodiment, the process according to the invention is performed without addition of a solvent and there is therefore no need to remove this solvent in an additional process step after the preparation of the polyoxyalkylene polyester polyol.

In one embodiment of the process according to the invention, the molar ratio of the lactone to the H-functional starter substance is from 1:1 to 30:1, preferably from 1:1 to 20:1.

Step i)

In step i) of the process according to the invention, the H-functional starter substance and the Brønsted-acidic catalyst are initially charged to form a mixture i), the mixture i) being prepared using appropriate mixing elements.

Step ii)

In one embodiment of the process according to the invention, the lactone is continuously added to the mixture i) in step ii).

In the process according to the invention, continuous addition of the lactone is understood to mean a volume flow of the lactone in step ii) of >0 ml/min, wherein the volume flow may be constant or may vary during this step ii).

In an alternative embodiment of the process according to the invention, the lactone is added stepwise to the mixture i) in step ii).

In the process according to the invention, stepwise addition of the lactone in step ii) is to be understood as meaning at least the addition of the entire lactone amount in two or more discrete portions of the lactone, wherein the volume flow of the lactone between the two or more discrete portions is 0 ml/min and wherein the volume flow of the lactone during a discrete portion may be constant or may vary.

The lactone is preferably added in 1 to 50, preferably 2 to 20, discrete portions.

The preparation of the mixture i) in step i), and the conversion thereof in step ii), is effected in reactors deemed suitable by those skilled in the art and having appropriate mixing elements.

The present invention further provides polyesters obtainable by the specified process according to the invention.

In one embodiment, the polyester according to the invention has a number-average molecular weight of 70 g/mol to 5000 g/mol, preferably of 80 g/mol to 4600 g/mol, the number-average molecular weight being determined by means of gel permeation chromatography (GPC) as disclosed in the experimental section.

The present invention further provides a process for preparing a polyurethane by reaction of the polyester according to the invention with a polyisocyanate.

The polyisocyanate may be an aliphatic or aromatic polyisocyanate. Examples include butylene 1,4-diisocyanate, pentane 1,5-diisocyanate, hexamethylene 1,6-diisocyanate (HDI) or their dimers, trimers, pentamers, heptamers or nonamers or mixtures thereof, isophorone diisocyanate (IPDI), 2,2,4- and/or 2,4,4-trimethylhexamethylene diisocyanate, isomeric bis(4,4′-isocyanatocyclohexyl)methanes or mixtures thereof having any desired isomer content, cyclohexylene 1,4-diisocyanate, phenylene 1,4-diisocyanate, tolylene 2,4- and/or 2,6-diisocyanate (TDI), naphthylene 1,5-diisocyanate, diphenylmethane 2,2′- and/or 2,4′- and/or 4,4′-diisocyanate (MDI) and/or higher homologs (polymeric MDI), 1,3- and/or 1,4-bis(2-isocyanatoprop-2-yl)benzene (TMXDI), 1,3-bis(isocyanatomethyl)benzene (XDI), and alkyl 2,6-diisocyanatohexanoates (lysine diisocyanates) having C1 to C6 alkyl groups. Preference is given here to an isocyanate from the diphenylmethane diisocyanate series.

In addition to the abovementioned polyisocyanates, it is also possible to co-use proportions of modified diisocyanates having a uretdione, isocyanurate, urethane, carbodiimide, uretonimine, allophanate, biuret, amide, iminooxadiazinedione and/or oxadiazinetrione structure and also unmodified polyisocyanate having more than 2 NCO groups per molecule, for example 4-isocyanatomethyloctane 1,8-diisocyanate (nonane triisocyanate) or triphenylmethane 4,4′,4″-triisocyanate.

In a first embodiment, the invention relates to a process for preparing a polyester by reaction of an H-functional starter substance with a lactone in the presence of a Brønsted-acidic catalyst, comprising the following steps:

i) initially charging the H-functional starter substance and the Brønsted-acidic catalyst to form a mixture i);
ii) adding the lactone to the mixture i);
wherein the process is performed without the addition of an aromatic solvent;
wherein the H-functional starter substance is an OH-functional starter substance and/or a COOH-functional starter substance and wherein the lactone is a 4-membered-ring lactone.

In a second embodiment, the invention relates to a process according to the first embodiment, wherein the 4-membered-ring lactone is one or more compounds and is selected from the group consisting of propiolactone, β-butyrolactone, diketene, preferably propiolactone and β-butyrolactone.

In a third embodiment, the invention relates to a process according to the first or second embodiment, wherein the lactone is continuously added to the mixture i) in step ii).

In a fourth embodiment, the invention relates to a process according to the first or second embodiment, wherein the lactone is added stepwise to the mixture i) in step ii).

In a fifth embodiment, the invention relates to a process according to any of the first to fourth embodiments, wherein the H-functional starter substance is one or more compounds and is selected from the group consisting of ethylene glycol, diethylene glycol, dipropylene glycol, butane-1,3-diol, butane-1,4-diol, 1,1,1-trimethylolpropane, glycerol, pentaerythritol, sorbitol, sucrose, xylitol, propane-1,2-diol, propane-1,3-diol, succinic acid, adipic acid, glutaric acid, pimelic acid, maleic acid, phthalic acid, terephthalic acid, lactic acid, citric acid and salicylic acid.

In a sixth embodiment, the invention relates to a process according to any of the first to fifth embodiments, wherein no solvent is used.

In a seventh embodiment, the invention relates to a process according to any of the first to sixth embodiments, wherein the Brønsted-acidic catalyst has a pKa of less than or equal to 1, preferably of less than or equal to 0.

In an eighth embodiment, the invention relates to a process according to any of the first to seventh embodiments, wherein the Brønsted-acidic catalyst is one or more compounds and is selected from the group consisting of aliphatic fluorinated sulfonic acids, aromatic fluorinated sulfonic acids, trifluoromethanesulfonic acid, perchloric acid, hydrochloric acid, hydrobromic acid, hydroiodic acid, fluorosulfonic acid, bis(trifluoromethane)sulfonimide, hexafluoroantimonic acid, pentacyanocyclopentadiene, picric acid, sulfuric acid, nitric acid, trifluoroacetic acid, methanesulfonic acid, paratoluenesulfonic acid, aromatic sulfonic acids and aliphatic sulfonic acids, preferably from trifluoromethanesulfonic acid, perchloric acid, hydrochloric acid, hydrobromic acid, hydroiodic acid, fluorosulfonic acid, bis(trifluoromethane)sulfonimide, hexafluoroantimonic acid, pentacyanocyclopentadiene, picric acid, sulfuric acid, nitric acid, trifluoroacetic acid, methanesulfonic acid, paratoluenesulfonic acid, methanesulfonic acid and paratoluenesulfonic acid, particularly preferably from trifluoromethanesulfonic acid, perchloric acid, hydrochloric acid, hydrobromic acid, hydroiodic acid, bis(trifluoromethane)sulfonimide, pentacyanocyclopentadiene, sulfuric acid, nitric acid and trifluoroacetic acid.

In a ninth embodiment, the invention relates to a process according to any of the first to eighth embodiments, wherein the Brønsted-acidic catalyst is used in an amount of 0.001 mol % to 0.5 mol %, preferably of 0.003 to 0.4 mol % and particularly preferably of 0.005 to 0.3 mol %, based on the amount of lactone.

In a tenth embodiment, the invention relates to a process according to any of the first to ninth embodiments, wherein the molar ratio of the lactone to the H-functional starter substance is from 1:1 to 30:1, preferably from 1:1 to 20:1.

In an eleventh embodiment, the invention relates to a polyester obtainable in accordance with any of the first to tenth embodiments.

In a twelfth embodiment, the invention relates to a polyester according to the eleventh embodiment, having a number-average molecular weight of 70 g/mol to 5000 g/mol, preferably of 80 g/mol to 4600 g/mol, the number-average molecular weight being determined by means of gel permeation chromatography (GPC) as disclosed in the experimental section.

In a thirteenth embodiment, the invention relates to a process for preparing a polyurethane by reaction of a polyester according to the eleventh or twelfth embodiment with a polyisocyanate.

In a fourteenth embodiment, the invention relates to a process according to the thirteenth embodiment, wherein the polyisocyanate is one or more compounds and is selected from the group consisting of butylene 1,4-diisocyanate, pentane 1,5-diisocyanate, hexamethylene 1,6-diisocyanate (HDI) or their dimers, trimers, pentamers, heptamers or nonamers or mixtures thereof, isophorone diisocyanate (IPDI), 2,2,4- and/or 2,4,4-trimethylhexamethylene diisocyanate, isomeric bis(4,4′-isocyanatocyclohexyl)methanes or mixtures thereof having any desired isomer content, cyclohexylene 1,4-diisocyanate, phenylene 1,4-diisocyanate, tolylene 2,4- and/or 2,6-diisocyanate (TDI), naphthylene 1,5-diisocyanate, diphenylmethane 2,2′- and/or 2,4′- and/or 4,4′-diisocyanate (MDI) and/or higher homologs (polymeric MDI), 1,3- and/or 1,4-bis(2-isocyanatoprop-2-yl)benzene (TMXDI), 1,3-bis(isocyanatomethyl)benzene (XDI), alkyl 2,6-diisocyanatohexanoates (lysine diisocyanates) having C1 to C6 alkyl groups.

### EXAMPLES

The present invention is elucidated in more detail by the figures and examples which follow, but without being limited thereto.

Starting Materials Used

Cyclic Lactones

β-Propiolactone (purity 98.5%, Ferak Berlin GmbH)

β-Butyrolactone (purity 98%, Sigma-Aldrich Chemie GmbH)

H-Functional Starter Substance

Ethylene glycol (EG, >99%, Oqema GmbH)

1,1,1-Trimethylolpropane TMP, (purity >99.8%, Perstorp AB)

Glycerol (Gly, purity 99.5%, Brenntag AG)

Propane-1,2-diol (PD, purity >99.8%, Brenntag AG)

Adipic acid (AA, purity 99.5% (BioXtra), Sigma Aldrich Chemie GmbH)

Octane-1,8-diol (OD, purity 98%, Sigma Aldrich GmbH)

PEG 300 (PE, purity Carl Roth GmbH+Co. KG)

Catalysts

Trifluoromethanesulfonic acid (TfOH, purity 98%, Sigma-Aldrich Chemie GmbH)

Sulfuric acid (H2SO4, 95-97%, Sigma Aldrich Chemie GmbH)

Solvent

Toluene (Tol, >99.5%, Azelis Deutschland GmbH)

Description of the Methods:

Gel permeation chromatography (GPC): Measurements were performed on an Agilent 1200 Series (G1311A Bin Pump, G1313A ALS, G1362A RID), detection by RID; eluent: tetrahydrofuran (GPC grade), flow rate 1.0 ml/min at 40° C. column temperature; column combination: 2×PSS SDV precolumn 100 Å (5 μm), 2×PSS SDV 1000 Å (5 μm). Calibration was carried out using ReadyCal Kit Poly(styrene) low in the range Mp=266-66000 Da from “PSS Polymer Standards Service”. The measurement recording and evaluation software used was the “PSS WinGPC Unity” software package. The polydispersity index from weighted (Mw) and number-average (Mn) molecular weight from the gel permeation chromatography is defined as Mw/Mn.

¹H NMR

1) The composition of the polymer was determined by ¹H NMR (Bruker DPX 400, 400 MHz; pulse program zg30, relaxation delay D1: 10 s, 64 scans). Each sample was dissolved in deuterated chloroform. The relevant resonances in the ¹H NMR (relative to TMS=0 ppm) and the assignment of the area integrals (A) are as follows:
poly(hydroxybutyrate) (=polybutyrolactone) with a resonance between 1.30-1.08 ppm, area integral corresponds to 3 hydrogen atoms (CH₃ group)
unsaturated impurities (free crotonic acid, unsaturated end groups of the polymer) with a resonance between 1.87-1.81+1.67-1.55 ppm (sum total of both integrals), each area integral corresponds to 3 hydrogen atoms (CH₃ group)

All areas stated are integrated to the sum of 1.00, where, after multiplication by 100, the molar proportion of the unsaturated impurities x_{unsaturated} [%] results.

If beta-propiolactone was polymerized under the conditions stated in the table, the measurement accuracy of the NMR for determining integrals of the double bonds was too inaccurate. Evaluation was not performed here, but the value is in all cases <1%.

2) The conversion of the monomer was determined by ¹H NMR (Bruker DPX 400, 400 MHz; pulse program zg30, relaxation delay D1: 10 s, 64 scans). Each sample was dissolved in deuterated chloroform. The relevant resonances in the ¹H NMR (relative to TMS=0 ppm) and the assignment of the area integrals (A) are as follows:
poly(hydroxybutyrate) (=polybutyrolactone) with resonances at 5.25 (1H), 2.61 (1H), 2.48 (1H) and 1.28 (3H).
β-butyrolactone with resonances at 4.70 (1H), 3.57 (1H), 3.07 (1H) and 1.57 (3H).
poly(hydroxypropionate) (=polypropiolactone) with resonances at 4.38 (2H) and 2.66 (2H)
β-propiolactone with resonances at 4.28 (2H) and 3.54 (2H) The conversion is determined as an integral of a suitable polymer signal divided by the sum of a suitable polymer signal and monomer signal. All signals are referenced to 1H.

Infrared Spectroscopy

The percentage lactone conversion, based on the amount of lactone used, was determined by means of IR spectroscopy. For this purpose, the product carbonyl bands (polypropiolactone, polybutyrolactone: 1780-1660 cm⁻¹) and the propiolactone reactant bands (e.g. reactant carbonyl bands 1800 cm⁻¹-1830 cm⁻¹) or butyrolactone reactant bands (1810 cm⁻¹-1825 cm⁻¹) were analyzed.

The percentage lactone conversion is then as follows:

X(lactone)[%]=F(polylactone)/[F(polylactone)+F(lactone)]*100 (III)

In formula (III), F (polylactone) is the area of the product carbonyl band at 1780-1660 cm⁻¹ and F (lactone) is the area of the reactant bands at 1800-1830 cm⁻¹ or 1810-1825 cm⁻¹.

### Examples 1.7.9, 10: Polyester Via Stepwise Lactone Addition without Addition of an Additional Solvent

A three-neck flask with a reflux condenser and precision glass stirrer was initially charged with 7.0 g (81.4 mmol, 0.29 eq.) of β-butyrolactone (BBL), trifluoromethanesulfonic acid (0.168 g, 1.12 mmol, 0.004 eq.) and ethylene glycol (17.3 g, 279 mmol, 1 eq.) (example 1, see table 1 for mass figures for examples 7, 9, 10). The clear solution was heated to 73° C. and the reaction process was monitored using ATR IR spectroscopy. After a conversion of the BBL of >70% was ascertained by means of IR spectroscopy (100 minutes), 7.0 g of BBL were added once again with no increase in temperature being observed. This procedure (addition of 6-7 g portions) was repeated until a total of 120.0 g (1.4 mol, 5 eq.) of BBL had been consumed. The highest temperature rise was from 70° C.-88° C., with the heat source not being removed. At the end of the reaction, the glass flask is cooled down and the polyol characterized by GPC analysis (molecular weight distribution) and ¹H NMR (conversion of the β-lactone, proportion of unsaturated compounds). In all cases, virtually complete conversions of the monomer could be achieved (≥99%). In addition, the molecular weight distributions were always monomodal and no signal of the free starter could be detected. As a result of the stepwise addition of the lactone, the steady-state amount of free lactone is considerably lower than in the batch process.

The mass figures for the remaining experimental examples can be gathered from table 1.

TABLE 1

| | m | m | m | m |
|---|---|---|---|---|
| Experiment | (butyrolactone) | (propiolactone) | (starter) | (TfOH) |
| number | [g] | [g] | [g] | [g] |
| 1 | 120 | — | 17.3 (EG) | 0.168 |
| 7 | 10 | — | 1.77 (PD) | 0.01 |
| 9 | 10 | — | 1.44 (EG) | 0.028 |
| | | | | (H₂SO₄) |
| 10 | — | 10 | 1.72 (EG) | 0.017 |

### Example 2 (Comparative Example): Polyester Via Batch Preparation Process

A four-neck flask with a reflux condenser and precision glass stirrer was initially charged with 100 g (1.16 mol, 5 eq.) of β-butyrolactone (BBL), trifluoromethanesulfonic acid (0.14 g, 0.933 mmol, 0.004 eq.) and ethylene glycol (14.4 g, 232 mmol, 1 eq.) at 10-15° C. The clear solution was then heated to approx. 45-50° C., the temperature at which the reaction begins to commence, and the reaction progress was monitored with IR spectroscopy. After two hours, despite stirring with a precision glass stirrer, a sharp jump in temperature with a temperature difference of >60° C. was observed and the oil bath was therefore immediately removed. After cooling to room temperature, IR spectroscopy showed that the BBL had been completely consumed. The glass flask was cooled down and the polyol characterized by GPC analysis (molecular weight distribution) and ¹H NMR (conversion of the β-lactone, proportion of unsaturated compounds). The conversion was almost complete (≥99%). In addition, the molecular weight distributions were monomodal and no signal of the free starter could be detected. If this experiment is conducted on a small scale (10 g of BBL), the temperature jump only occurs from 55° C.

### Example 3 (Comparative Example): Polyester Via Batch Preparation Process

Analogously to example 2, 0.0125 eq. of TfOH (=0.25 mol %), 10 g of BBL were used. As soon as the internal temperature of 45° C. had been exceeded, a sharp temperature rise with a temperature difference ΔT of >60° C. was observed and the heat source was removed immediately. The glass flask was cooled down and the polyol characterized by GPC analysis (molecular weight distribution) and ¹H NMR (conversion of the β-lactone, proportion of unsaturated compounds). The conversion was almost complete (≥99%). In addition, the molecular weight distributions were monomodal and no signal of the free starter could be detected. However, a significant proportion of unsaturated byproducts of 10% was detected by means of H NMR spectroscopy. In the original prior art, 1 mol % of TfOH was used as a minimum amount with a BBL amount of 200 μl. On a >10 g scale, this experiment would lead to a larger, uncontrollable temperature rise and was not carried out for safety reasons.

### Example 4 (Comparative Example): Polyester Via Batch Preparation Process Using an Aromatic Solvent

A three-neck flask with a reflux condenser and magnetic stirrer was initially charged with 10 g (0.116 mol, 5 eq.) of β-butyrolactone (BBL) in toluene. Thereafter, trifluoromethanesulfonic acid (0.014 g, 0.0933 mmol, 0.004 eq.) and ethylene glycol (1.44 g, 23.2 mmol, 1 eq.) were added successively at 10-15° C. The clear solution was then heated to approx. 45-50° C. and the reaction progress was monitored with IR spectroscopy. After 100 minutes and heating to 62° C., despite stirring, a jump in temperature of >20° C. was observed and the heating of the oil bath was immediately switched off. After cooling to 64° C., the reaction was continued and monitored by means of IR spectroscopy. At the end of the reaction, the glass flask was cooled down and the polyol characterized by GPC analysis (molecular weight distribution) and ¹H NMR (conversion of the β-lactone, proportion of unsaturated compounds). The conversion was almost complete (≥99%). In addition, the molecular weight distributions were monomodal and no signal of the free starter could be detected. Again, a direct comparative example with at least 1 mol % of TfOH was dispensed with due to an uncontrollable temperature rise and the accompanying safety risks.

### Example 5 (Comparative Example): Polyester Via Stepwise Lactone Addition Using an Aromatic Solvent

A three-neck flask with a reflux condenser and magnetic stirrer was initially charged with 1 g (0.0116 mol, 0.5 eq.) of β-butyrolactone (BBL), trifluoromethanesulfonic acid (0,014 g, 0.0933 mmol, 0.004 eq.), 10 ml of toluene and ethylene glycol (1.44 g, 23.2 mmol, 1 eq.) at 10-15° C. The clear solution was then heated to approx. 50-76° C. and the reaction progress was monitored with IR spectroscopy. After two hours, the conversion of the reaction according to IR spectroscopy was only approx. 14% (total amount of BBL planned: 10 g) and the batch was discarded, even though the portion-wise addition of the remaining 9 g of BBL remained to be done.

### Examples 6, 8, 11-13: Polyester Via Continuous Lactone Addition

A 500 ml flange reactor is initially charged with 1. starter (amount: table 2) and 2. catalyst (amount: table 2) with the briefest possible contact with air. The reactor is closed, the stirrer is switched on (200-400 rpm) and purging is effected for 10-15 min with N₂ (approx. 1 bubble/s). 10 g of lactone are added and the thermostat is then set to 60° C. The reaction is stirred for 60 min. A sample is then taken and IR measurement effected. If the conversion is <50%, the temperature is increased to 70° C. and the mixture is stirred for a further 60 min, A sample is then taken again and IR measurement effected. If the conversion is >50%, the reaction temperature is increased to 70° C. and a changeover to continuous metering is effected (flow rate of lactone of 0.5 g/min). The mixture is then stirred for a further 30 min and the conversion checked via IR. Stirring is continued until complete conversion has taken place (IR). At the end of the reaction, the flange reactor is cooled down and the polyol characterized by GPC analysis (molecular weight distribution) and ¹H NMR (conversion of the β-lactone). In all cases, virtually complete conversions of the monomer could be achieved (≥99%). In addition, the molecular weight distributions were always monomodal and no signal of the free starter could be detected.

TABLE 2
Overview of the amounts weighed in in experiments 6, 8, 11-13.

| | m | m | m | m |
|---|---|---|---|---|
| Experiment | (propiolactone) | (butyrolactone) | (starter) | (TfOH) |
| number | [g] | [g] | [g] | [g] |
| 6 | — | 96.5 | 3.48 | 0.135 |
| 8 | 81.6 | — | 18.4 | 0.136 |
| 11 | 87.6 | — | 12.4 | 0.146 |
| 12 | 79.4 | — | 20.7 | 0.132 |
| 13 | 70.8 | — | 29.2 | 0.118 |

### Examples 14-18 (Comparative Examples): Polyester Via Stepwise/Continuous Lactone Addition in the Presence of a DMC Catalyst

A 300 ml steel autoclave is initially charged with 1. starter, 2. catalyst (amount: table 3) and 3. solvent with the briefest possible contact with air. The reactor is purged with N₂. At 130° C., the β-lactone is then continuously fed into the reactor over two hours. This was then followed by stirring for about two hours. Via IR analysis of the reaction solution, the reaction time and temperature of the following stirring time were optionally adapted in order to ensure complete conversion of the β-lactone. No exothermicity was observed during the time period of the continuous metering and the following stirring time. When using low molecular weight starter compounds (e.g. ethylene glycol), the starter is metered continuously into the reaction solution analogously to the monomer.

At the end of the reaction, the reactor is cooled down, volatile components are removed from the reaction solution and the polyol is characterized by GPC analysis (molecular weight distribution) and ¹H NMR (conversion of the β-lactone). In all cases, virtually complete conversions of the monomer could be achieved (≥95%), however unsaturated impurities were detected in the range of 2-7%. In addition, in all cases clear-cut setting of the molecular weight was not possible. The molecular weight distributions were always bimodal and, in addition to the polyester, in all cases free starter was additionally present in the product.

No solvent was used in experiment 18.

TABLE 3
Overview of the amounts weighed in in experiments 14-18.

| | m | m | m | m |
|---|---|---|---|---|
| Experiment | (toluene) | (butyrolactone) | (starter) | (DMC) |
| number | [g] | [g] | [g] | [g] |
| 14 | 50 | 18.5 | 1.46 | 0.02 |
| 15 | 50 | 17.1 | 2.92 | 0.02 |
| 16 | 50 | 19.4 | 0.62 | 0.02 |
| 17 | 50 | 18.7 | 1.24 | 0.02 |
| 18 | — | 62.3 | 11.0 | 0.073 |

TABLE 4
Comparison of experiments 1 to 18.

| | Addition | | H-funct. | | | Lactone/ | | | | X(lactone) | | |
|---|---|---|---|---|---|---|---|---|---|---|---|---|
| | of | | starter | | x(cat) [mol %]^{b)} | starter | | Mn | | [%] ¹H | X_{unsaturated} | ΔTₘₐₓ |
| Experiment | lactone^{a)} | Lactone | substance | Catalyst | [ppm]^{c)} | [mol/mol] | Solvent | [g/mol] | PDI | NMR | [%] | [° C.] |
| 1 | sw | BBL | EG | TfOH | 0.08^{b)} 1200^{c)} | 5/1 | — | 610 | 1.3 | ≥99 | 0 | 18 |
| 2 (comp.) | batch | BBL | EG | TfOH | 0.08^{b)} 1200^{c)} | 5/1 | — | 690 | 1.2 | ≥99 | 1 | >60 |
| 3 (comp.) | batch | BBL | EG | TfOH | 0.25^{b)} 1200^{c)} | 5/1 | — | 500 | 1.7 | ≥99 | 10 | >60 |
| 4 (comp.) | batch | BBL | EG | TfOH | 0.08^{b)} 1200^{c)} | 5/1 | toluene | 660 | 1.1 | ≥99 | 1 | >20 |
| 5 (comp.) | sw | BBL | EG | TfOH | 0.08^{b)} 1200^{c)} | 5/1 | toluene | n.d. | n.d. | n.d. | n.d. | 0 |
| 6 | cont. | BBL | EG | TfOH | 0.08^{b)} 1200^{c)} | 20/1 | — | 2000 | 1.4 | ≥99 | 0 | 0 |
| 7 | sw | BBL | PD | TfOH | 0.08^{b)} 1200^{c)} | 5/1 | — | 780 | 1.2 | ≥99 | 3 | 17 |
| 8 | cont. | BPL | Gly | TfOH | 0.08^{b)} 1200^{c)} | 5.6/1 | — | 820 | 1.4 | ≥99 | — | 0 |
| 9 | sw | BBL | EG | H₂SO₄ | 0.08^{b)} 2440^{c)} | 5/1 | — | 600 | 1.4 | ≥99 | 3 | 6 |
| 10 | sw | BPL | EG | TfOH | 0.08^{b)} 1200^{c)} | 5/1 | — | 880 | 1.4 | ≥99 | — | 10 |
| 11 | cont. | BPL | EG | TfOH | 0.08^{b)} 1200^{c)} | 5/1 | — | 920 | 1.5 | ≥99 | — | 0 |
| 12 | cont. | BPL | EG | TfOH | 0.08^{b)} 1200^{c)} | 3/1 | — | 560 | 1.3 | ≥99 | — | 0 |
| 13 | cont. | BPL | AA | TfOH | 0.08^{b)} 1200^{c)} | 5/1 | — | 420 | 1.3 | ≥99 | — | 0 |
| 14 | cont. | BBL | OD | DMC | 1000^{c)} | 21.5/1 | toluene | 2500 + 6000 | mm | ≥95 | 7 | 0 |
| (comp.) | | | | | | | | | | | | |
| 15 | cont. | BBL | OD | DMC | 1000^{c)} | 10/1 | toluene | 2000 + 4500 | mm | ≥95 | 3 | 0 |
| (comp.) | | | | | | | | | | | | |
| 16 | cont. | BBL | EG | DMC | 1000^{c)} | 22.5/1 | toluene | 1300 + 2500 | mm | ≥95 | 3 | 0 |
| (comp.) | | | | | | | | | | | | |
| 17 | cont. | BBL | EG | DMC | 1000^{c)} | 11/1 | toluene | 2200 + 4200 | mm | ≥95 | 2 | 0 |
| (comp.) | | | | | | | | | | | | |
| 18 | cont. | BBL | PE | DMC | 1000^{c)} | 20/1 | — | 2000 + 4500 | mm | ≥95 | 4 | 0 |
| (comp.) | | | | | | | | | | | | |

^{a)}addition of lactone, batch, stepwise (sw), continuous (cont.),
^{b)+c)}catalyst amount [mol %]^{b)} or [ppm]^{c)} X_{unsaturated} [%]
^{d)}proportion of unsaturated impurities
n.d.: not determined, mm: multimodal

1. A process for preparing a polyester by reaction of an H-functional starter substance with a lactone in the presence of a Brønsted-acidic catalyst, comprising:
i) initially charging the H-functional starter substance and the Brønsted-acidic catalyst to form a mixture i); and
ii) adding the lactone to the mixture i);
wherein the process is performed without the addition of an aromatic solvent;
wherein the H-functional starter substance comprises an OH-functional starter substance and/or a COOH-functional starter substance;
and wherein the lactone comprises a 4-membered-ring lactone.

2. The process as claimed in claim 1, wherein the 4-membered-ring lactone comprises propiolactone, β-butyrolactone, diketene, preferably propiolactone, β-butyrolactone, or a mixture thereof.

3. The process as claimed in claim 1, wherein the lactone is continuously added to the mixture i) in step ii).

4. The process as claimed in claim 1, wherein the lactone is added stepwise to the mixture i) in step ii).

5. The process as claimed in claim 1, wherein the H-functional starter substance comprises ethylene glycol, diethylene glycol, dipropylene glycol, butane-1,3-diol, butane-1,4-diol, 1,1,1-trimethylolpropane, glycerol, pentaerythritol, sorbitol, sucrose, xylitol, propane-1,2-diol, propane-1,3-diol, succinic acid, adipic acid, glutaric acid, pimelic acid, maleic acid, phthalic acid, terephthalic acid, lactic acid, citric acid, salicylic acid, or a mixture thereof.

6. The process as claimed in claim 1, wherein no solvent is used.

7. The process as claimed in claim 1, wherein the Brønsted-acidic catalyst has a pKa of less than or equal to 1.

8. The process as claimed in claim 1, wherein the Brønsted-acidic catalyst comprises an aliphatic fluorinated sulfonic acid, an aromatic fluorinated sulfonic acid, trifluoromethanesulfonic acid, perchloric acid, hydrochloric acid, hydrobromic acid, hydroiodic acid, fluorosulfonic acid, bis(trifluoromethane)sulfonimide, hexafluoroantimonic acid, pentacyanocyclopentadiene, picric acid, sulfuric acid, nitric acid, trifluoroacetic acid, methanesulfonic acid, paratoluenesulfonic acid, an aromatic sulfonic acid an aliphatic sulfonic acid, or a mixture thereof.

9. The process as claimed in claim 1, wherein the Brønsted-acidic catalyst is used in an amount of 0.001 mol % to 0.5 mol %, based on the amount of lactone.

10. The process as claimed in claim 1, wherein the molar ratio of the lactone to the H-functional starter substance is from 1:1 to 30:1.

11. A polyester obtained by the process of claim 1.

12. The polyester as claimed in claim 11, having a number-average molecular weight of 70 g/mol to 5000 g/mol as determined by means of gel permeation chromatography (GPC).

13. A process for preparing a polyurethane comprising reacting the polyester as claimed in claim 11 with a polyisocyanate.

14. The process as claimed in claim 13, wherein the polyisocyanate comprises butylene 1,4-diisocyanate, pentane 1,5-diisocyanate, hexamethylene 1,6-diisocyanate (HDI) or their dimers, trimers, pentamers, heptamers or nonamers or mixtures thereof, isophorone diisocyanate (IPDI), 2,2,4- and/or 2,4,4-trimethylhexamethylene diisocyanate, isomeric bis(4,4′-isocyanatocyclohexyl)methanes or mixtures thereof having any desired isomer content, cyclohexylene 1,4-diisocyanate, phenylene 1,4-diisocyanate, tolylene 2,4- and/or 2,6-diisocyanate (TDI), naphthylene 1,5-diisocyanate, diphenylmethane 2,2′- and/or 2,4′- and/or 4,4′-diisocyanate (MDI) and/or higher homologs (polymeric MDI), 1,3- and/or 1,4-bis(2-isocyanatoprop-2-yl)benzene (TMXDI), 1,3-bis(isocyanatomethyl)benzene (XDI), alkyl 2,6-diisocyanatohexanoates (lysine diisocyanates) having C1 to C6 alkyl groups, or a mixture thereof.
